(19) United States
(12) Patent Application Publication
(10) Pub. No.: US 2007/0158560 A1
(43) Pub. Date: Jul. 12, 2007

(54) Charged particle beam system, semiconductor inspection system, and method of machining sample

(75) Inventors: Noriyuki Kaneoka, Hitachinaka (JP); Kaoru Umemura, Tokyo (JP); Koji Ishiguro, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/646,421

(22) Filed: Dec. 28, 2006

(30) Foreign Application Priority Data
Dec. 28, 2005 (JP) 2005-379193

(51) Int. Cl. G21K 7/00

(52) U.S. Cl. 250/309

(57) ABSTRACT

Provided is a technique for accurately taking out a defect detected by an electron beam, and for analyzing the defect. In this technique, a defective portion in a wafer is detected by the irradiation of the electron beam. A mark made of a deposition layer is formed by irradiating the electron beam onto the defective portion while supplying a deposition gas thereto. On the basis of this mark, the defective portion is machined into a sample piece by using a projection ion beam generated from a gas ion source, and thereby the defective portion is taken out.

The present application claims priority from Japanese application JP 2005-379193 filed on Dec. 28, 2005, the content of which is hereby incorporated by reference into this application.

### BACKGROUND OF THE INVENTION

1. Field of the Invention

The present invention relates to a semiconductor inspection system used in a defect inspection in a process of manufacturing semiconductor devices, and in particular to a semiconductor inspection system and an ion beam machining method, which are capable of accurately taking out a defective portion which is detected by irradiating an electron beam.

2. Description of the Related Art

In the manufacture of semiconductor devices, such as a microprocessor and a memory, a high yield with few defective devices produced is desired. In recent years, as the cause of a defect reducing the yield of semiconductor devices, increasing are electrical defects such as a conducting defect and a short circuit associated with the reduction in size of the structure. Heretofore, in order to detect such electrical defects, an inspection is carried out by means of an LSI tester or the like using a probe (needle) at a stage where manufacturing the function of a device is completed. However, in order to improve the yield in a shorter period of time, it is an important point to early detect (find out) the cause of defects, and to take countermeasures against it at an earlier stage. For this reason, an inspection is carried out on a wafer in the course of processing. In this case, it is required to return the wafer after the inspection to the manufacturing process.

In order to analyze the cause of electrical defects, it is effective to observe the cross section of a portion which has been determined as a defective portion in the inspection. In order to observe the cross section, there is the following method. In the method, a sample, such as a wafer, is irradiated with an ion beam, and the surface of the sample is etched by use of the sputtering phenomenon. The cross section of the sample is then observed with an SEM (a scanning electron microscope), and thereby the cause of a defect is analyzed. However, with the downsizing of semiconductor devices, the image resolution of the scanning electron microscope is becoming insufficient for the purpose of observing the cross section of a sample. Then, there is a technique in which a part of a sample is taken out as a sample piece by means of an ion beam machining, and the sample piece is observed and analyzed using a high-resolution scanning electron microscope or a transmission electron microscope.

In a general method, LMIS (liquid metal ion source) using a liquid metal such as Ga (gallium) is used as an ion source of an ion beam. In the case of an ion beam machining apparatus using LMIS, there is a problem that metal of LMIS adheres to a surface of a sample on which an ion beam is irradiated, thereby contaminating the surface. For the purpose of solving the problem, proposed is an ion beam machining apparatus using a gas ion source as an ion source but not LMIS. An example of this is disclosed in Japanese Patent Application Publication No. 2005-10014, titled as “Method of Machining Sample by means of Ion Beam, Ion beam Machining Apparatus, Ion Beam Machining System, and Method of Manufacturing Electronic Part Using The Same.”

### SUMMARY OF THE INVENTION

The ion beam using a gas ion source is a projection beam. The projection beam has an advantage that the speed of machining is fast due to its large beam current, but also has a disadvantage that it is incapable of being narrowed. Even when the projection beam is narrowed with an objective lens, the diameter of the narrowed projection beam is on the order of 200 mn, and it is impossible to narrow the projection beam as finely as the ion beam using a liquid metal ion source, which diameter can be made several nm. For this reason, with the projection beam, the SIM (scanning ion microscope) image produced by the secondary electrons and reflection electrons, which are generated from a sample by scanning the ion beam thereon, will not be a high resolution image. This presents a problem that for devices with a fine structure, a defective portion may not be identified. For example, in a case where the diameter of an ion beam is 200 nm, if there is a structure in which contact holes of 100 nm diameter are arranged at intervals of 200 nm, it is impossible to obtain an image for recognizing this structure. In the case of the beam of 200 nm diameter, from the sampling theorem, only a structure, in which contact holes are arranged at intervals of at least 400 nm, can be recognized from an image generated therefrom.

On the other hand, since the electron beam of an SEM column may be narrowed down to several nm or less, this makes it possible to display the state of each contact hole. Moreover, in this case, from the difference in contrast, which is termed as VC (voltage contrast), a conducting defect and a short circuit within a contact hole may be also detected. Here, in a case where a certain contact hole is darker or brighter than other contact holes, this contact hole is determined as defective, depending on the level of the difference. As the cause of the defect, an internal conducting defect and a short circuit may be considered. However, the analysis is difficult if the defect exists in a thin film portion. Accordingly, the contact hole determined as defective needs to be taken out in order to carry out the analysis using a high resolution TEM and STEM. In this case, with an image obtained by scanning an ion beam, the position of the contact hole may not be identified Moreover, in a case where either one or both of the SEM column and the ion beam are inclined, the height of a wafer needs to be when attempting to observe the same position. When the height changes, the position to be observed changes. For this reason, it is difficult to take out a defective contact hole, which is detected by an electron beam of an SEM column, accurately by machining using an ion beam.

It is an object of the present invention to provide a semiconductor inspection system, which is provided with an ion beam column using a gas ion source, and which is capable of accurately taking out a defective portion of a fine semiconductor device, the defective portion being detected by irradiating an electron beam, and also to provide a method of machining a sample using an ion beam.

In the present invention, a defect, which occurs in a sample in the process of manufacturing a semiconductor, is detected on the basis of a sample image obtained by the irradiation of an electron beam. By using an ion beam, the area of the defective portion thus detected is machined into such a sample piece that can be analyzed with a high-resolution analysis system, and then this sample piece is taken out. By irradiating an electron beam onto the detected defective position while supplying a deposition gas thereto, a mark is formed of a deposition layer in the sample surface. On the basis of this mark, a machining using an ion beam is carried out on the sample. The ion beam used in the machining is generated by a gas ion source which does not contain elements causing a contamination problem in the semiconductor process, and is a projection beam with a fast machining speed. The deposition layer is typically made of oxide, and the deposition gas for forming the deposition layer is made of a material which does not contain elements causing a contamination problem in the semiconductor process.

According to the present invention, a defective portion detected by the irradiation of an electron beam may be accurately taken out by using a pollution-free ion beam, a deposition gas source, and a probe. Accordingly, the wafer after taking out this sample piece is pollution-free and may be returned to the manufacturing process, thereby reducing the disposal wafers.

### BRIEF DESCRIPTION OF THE DRAWINGS

FIG. 1 is a view showing a configuration example of a semiconductor inspection system according to the present invention.

FIGS. 2A and 2B are explanatory views showing the difference between beam modes of an ion beam.

FIGS. 3A and 3B are views showing the difference between masks corresponding to the beam mode.

FIG. 4 is a flowchart showing a flow of taking out a sample piece.

FIG. 5 is a view showing a structure of a cartridge.

FIG. 6 is a view showing a structure of a wafer holder.

FIG. 7 is a view showing an example of an inspection result of a semiconductor device.

FIG. 8 is a view showing a marking by means of an electron beam.

FIG. 9 is a view showing an example of a mark by means of a deposition layer.

FIG. 10 is a view showing an image acquisition in a scanning ion beam mode.

FIG. 11 is a view in which a mark of deposition layer is displayed by a scanning ion beam.

FIG. 12 is a view showing a state where machining is carried out using a machining ion beam.

FIG. 13 is a view showing another state where the machining is carried out using the machining ion beam.

FIG. 14 is a view showing a result of the machining by the machining ion beam.

FIG. 15 is a view showing a state where a sample piece is taken out with a probe.

FIG. 16 is a view showing a machining hole after the sample piece is taken out.

FIG. 17 is a view showing the refilling of the machining hole.

FIG. 18 is a view showing a state where the sample piece is fixed to a sample carrier in a cartridge. FIG. 19 is a view showing a configuration example of the cartridge and a sample holder.

FIG. 20 is a view showing an example of a machining region at the time of thin machining a sample piece.

FIG. 21 is a view showing a state where the sample piece is laminated.

FIG. 22 is a view showing another configuration example of the semiconductor inspection system according to the present invention.

FIG. 23 is a view showing a machining state using an L-shaped mask.

FIG. 24 is a view showing a machining state using the L-shaped mask.

FIGS. 25A and 25B are views showing a machined result using the L-shaped mask.

FIGS. 26A and 16B are views showing the structure of a variable mask.

FIG. 27 is a view showing a state of the variable mask.

FIG. 28 is a view showing a state of the variable mask.

FIG. 29 is a view showing a state of the variable mask.

### DETAILED DESCRIPTION OF THE PREFERRED EMBODIMENTS

Hereinafter, embodiments of the present invention will be described with reference to the accompanying drawings.

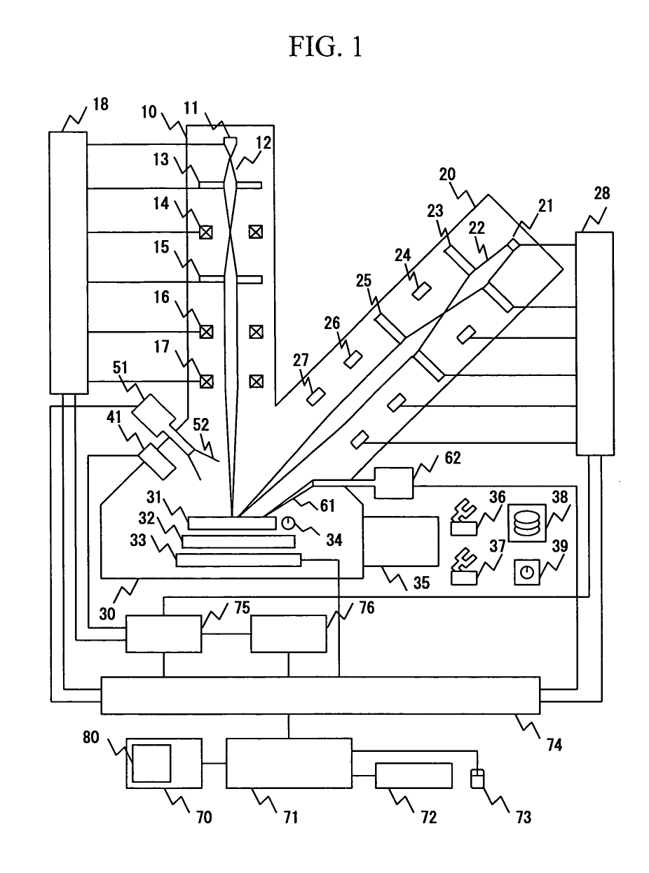

FIG. 1 is a view showing a first embodiment of a semiconductor inspection system of the present invention. A sample chamber 30 includes a SEM column (electron beam column) 10, an ion beam column 20, a detector 41, a deposition gas source 51 and a probe moving mechanism 62. As a gas supplied from the deposition gas source 51, tetra-ethyl-ortho-silicate (TEOS) or the like is used. TEOS is decomposed by a beam irradiation to form silicone oxide. The SEM column 10 includes an electron source 11, an extractor electrode 13, a condenser lens 14, a beam aperture 15, a deflector 16 and an objective lens 17, and the inside of the SEM column 10 is kept at a high vacuum. The ion beam column 20 includes an ion source 21, an extractor electrode 23, a condenser lens 24, a mask 25, a deflector 26 and an objective lens 27, and the inside of the ion beam column 20 is kept at a high vacuum. To the inside of the sample chamber 30, provided are a wafer holder 32 holding a wafer 31 and a cartridge 34, and a sample stage 33 on which a wafer holder 32 is mounted. A sample exchange chamber 35 is used for loading and unloading the wafer 31 and the cartridge 34 to and from the sample chamber 30 without degrading the degree of vacuum of the sample chamber 30. The SEM column 10 is controlled by a SEM control unit 18, and the ion beam column 20 is controlled by an ion beam column control unit 28. An image generation unit 75 captures a signal of the detector 41 in synchronization with a scanning signal of each beam, and generates an image. An image processing unit 76 compares an image generated by the image generation unit 75 in the unit of a cell or a die of the semiconductor manufacturing process, and detects a defective portion from the difference. A whole control unit 74 controls the whole components, such as the sample stage 33, the deposition gas source 51 and the probe moving mechanism 62. An operation unit is constituted of a computer 71 including a display 70, a keyboard 72 and a mouse 73.

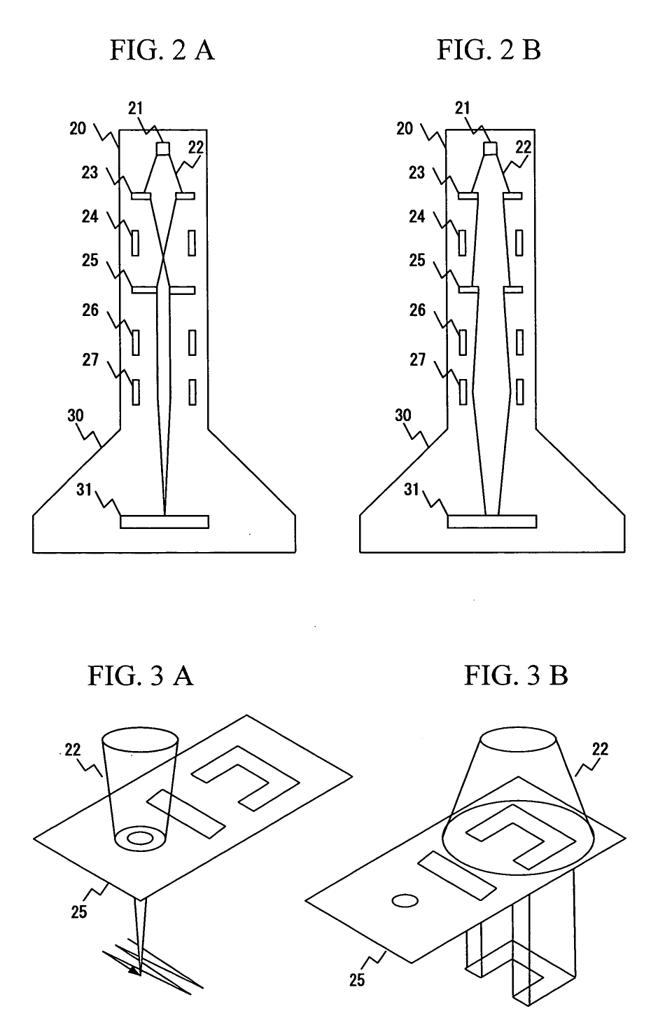

The ion source 21 of the ion beam column 20 turns a gas, such as Ar (argon), into plasma, and thereby an ion beam 22 is generated. The ion beam 22 generated using the gas ion source serves as a projection beam having a wide width. At least two types of beam modes are provided by controlling the ion beam column 20. The first beam mode is a mode, as shown in FIG. 2A, in which an ion beam narrowed by the condenser lens 24 is transmitted through a mask 25, and thereafter is scanned and deflected by the deflector 26, and is focused on the wafer 31 by the objective lens 27. The beam of this mode will be referred to as a scanning ion beam. Although this mode is a mode used for determining a machining position, the beam diameter may be narrowed down to just on the order of 200 nm. The second beam mode is a mode, as shown in FIG. 2B, in which a beam is not narrowed by the condenser lens 24, but the projection beam formed into the shape of the mask 25 is reduced and projected by the objective lens 27 and thereby the machining is carried out. The beam in this mode will be referred to as a machining ion beam. This mode may increase the beam current to be irradiated, and accelerate the machining speed.

The mask 25 is, as shown in FIGS. 3A and 3B, a thin plate in which a circular hole used for the scanning ion beam and a hole corresponding to a machining shape used for the machining ion beam are opened, and the number of holes and shapes may be multiple. The beam mode is set by moving the mask 25. FIG. 3A is a view showing a state where the scanning ion beam is set. In this state, a beam is narrowed down to be formed into the ion beam 22 corresponding to the circular hole by means of the condenser lens 24, and is transmitted through the mask 25. Thereafter, the beam is scanned by the deflector 26, and is focused by the objective lens 27. FIG. 3B is a view showing a state where the machining ion beam is set. In this state, a beam is formed into the ion beam 22 corresponding to the machining hole by means of the condenser lens 24, and is transmitted through the mask 25. Thereafter, the position of the beam is corrected by the deflector 26, and the beam is reduced and projected by the objective lens 27.

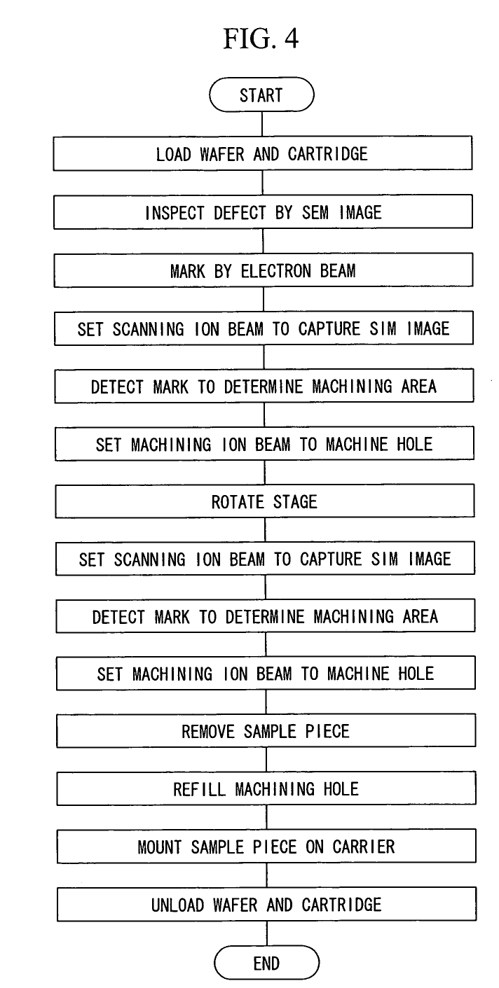

FIG. 4 illustrates a flowchart showing a series of processes from loading a wafer to the semiconductor inspection system of the present invention, to taking out a sample piece, refilling a machined hole, and unloading the wafer. Hereinafter, the description is made following this flow.

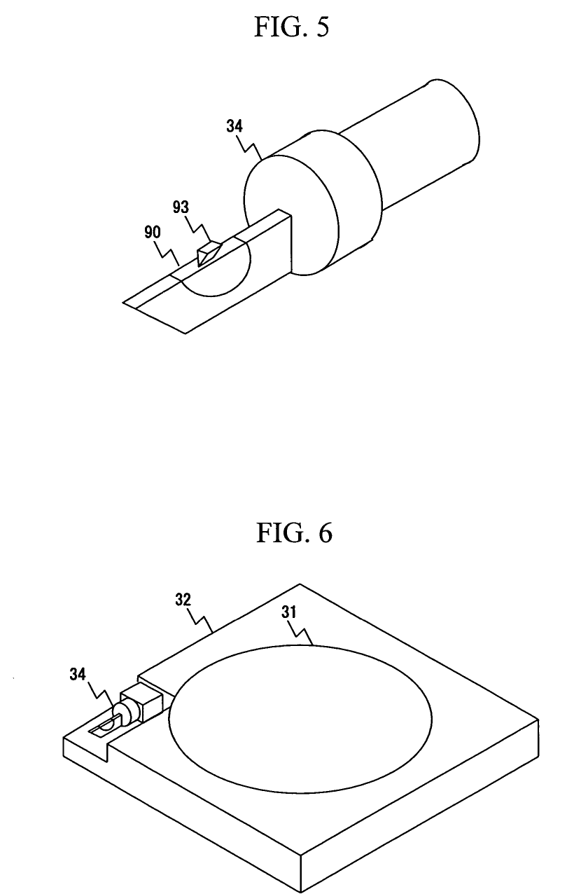

In the wafer inspection process of the semiconductor manufacturing process, the wafer 31 is stored in a wafer case 38 and mounted on a load port. A wafer carry robot 36 takes out the wafer 31 stored in the wafer case 38, and moves to above the wafer holder 32 in the sample exchange chamber 35 under ambient conditions. In addition, a cartridge 34 is provided as a container for moving a sample piece 93, which is taken out from the wafer 31, to high resolution analysis equipment. FIG. 5 is a view showing a configuration of the cartridge 34, and showing a state where the cartridge 34 holds a sample carrier 90 for fixing the sample piece 93. A cartridge carry robot 37 takes out the cartridge 34 stored in the cartridge case 39, and moves the cartridge 34 to above the wafer holder 32 in the sample exchange chamber 35 under ambient conditions. FIG. 6 is a view showing a configuration of the wafer holder 32 which is capable of mounting the cartridge 34 as well as mounting the wafer 31. Moreover, the wafer holder 32 incorporates a mechanism capable of inclining the cartridge 34. The wafer holder 32 on which the wafer 31 and cartridge 34 are mounted is moved onto the stage 33 in the sample chamber 30 after the sample exchange chamber 35 is evacuated to a vacuum.

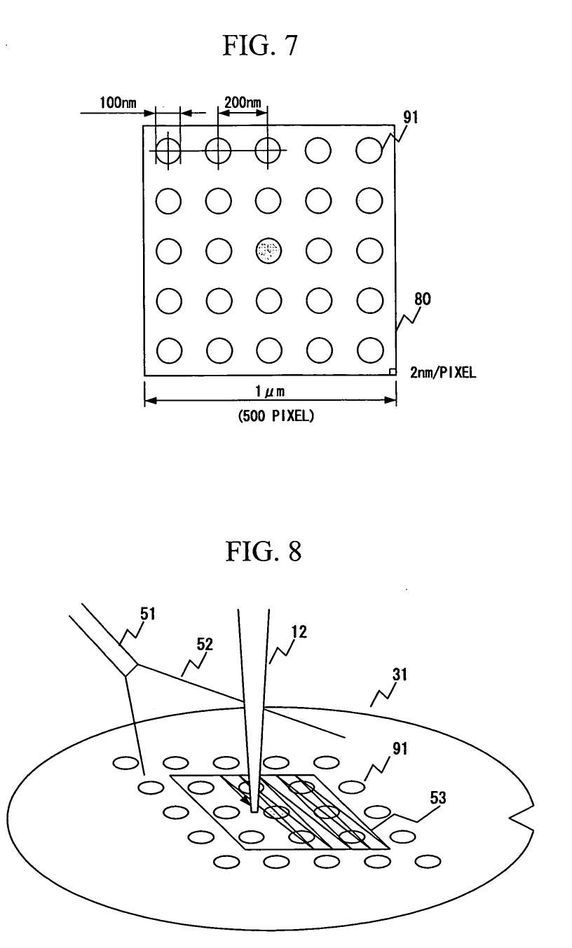

After the amount of current of an electron beam 12 extracted from the electron source 11 by means of an electric field of the extractor electrode 13 of the SEM column 10 is adjusted by the condenser lens 14 and beam aperture 15, the electron beam 12 is scanned and deflected by the deflector 16. The electron beam 12 is then narrowed by the objective lens 17, and is irradiated onto the wafer 31. From the wafer 31 which is irradiated with the electron beam 12, signals such as secondary electrons, reflecting electrons and the like are outputted depending to the shape, the surface of the quality and the like of the wafer 31. Moreover, the amount of the outputted signals varies depending on electrical defects, such as a conducting defect and short circuit inside the wafer. An SEM image is generated in the image generation unit 75 by capturing the signal of the detector 41 in synchronization with a scanning signal of the electron beam 12. The SEM image thus generated is then compared in the unit of a cell or a die in the image processing unit 76, and thereby a defective portion is detected. For example, as shown in FIG. 7, in a case where contact holes with a diameter of 100 nm are arranged at intervals of 200 nm, when a contact hole in the center is darker than other contact holes, the presence of a defect inside may be determined in accordance with this level.

While this equipment is equipped with a SEM column having a resolution of several nm, it is preferable that an electrical defect inside be observed and analyzed with a high resolution analysis system. This is because the electrical defect inside is a defect in a fine structure, such as a short circuit due to defects in an insulating layer. For this reason, the defective portion is taken out, and is observed and analyzed by a high resolution analysis system, such as TEM (Transmission Electron Microscope) or STEM (Scanning Transmission Electron Microscope). Accordingly, the defective portion is machined into a sample piece by an ion beam, and then is taken out.

In a region where contact holes with a diameter of 100 nm as shown in FIG. 7 are sequentially arranged at intervals of 200 nm, in a case where a defect of one contact hole is detected by the SEM column 10, the contact hole may not be identified by an image obtained by means of an ion beam, because the beam diameter of the ion beam column is 200 nm. Moreover, the defect, which may be detected by an electron beam having minus charges, may not be detected by an ion beam having plus charges. Then, a mark having the length of one side of 400 nm or more, which is recognizable by an SIM image by means of the scanning of the ion beam 22, is formed in the vicinity of the defective portion by the electron beam 12.

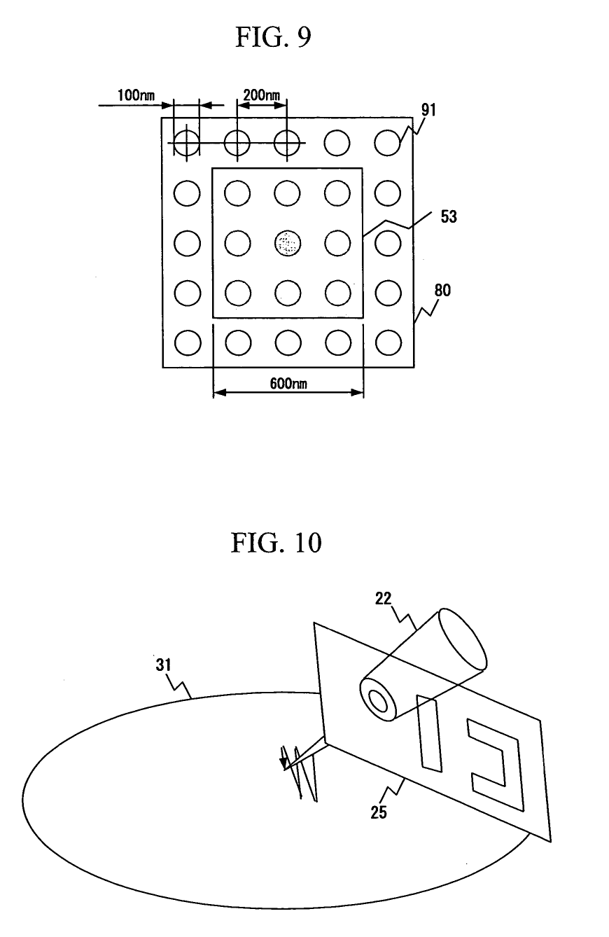

As shown in FIG. 8, a deposition layer 53 is formed by supplying a deposition gas 52 from the deposition gas source 51 and scanning the electron beam 12 thereon. For example, as shown in FIG. 9, a region, having a length of 600 nm on one side, and centering around one defective contact hole 91, is scanned by the electron beam 12, and thereby a mark is formed of the deposition layer 53.

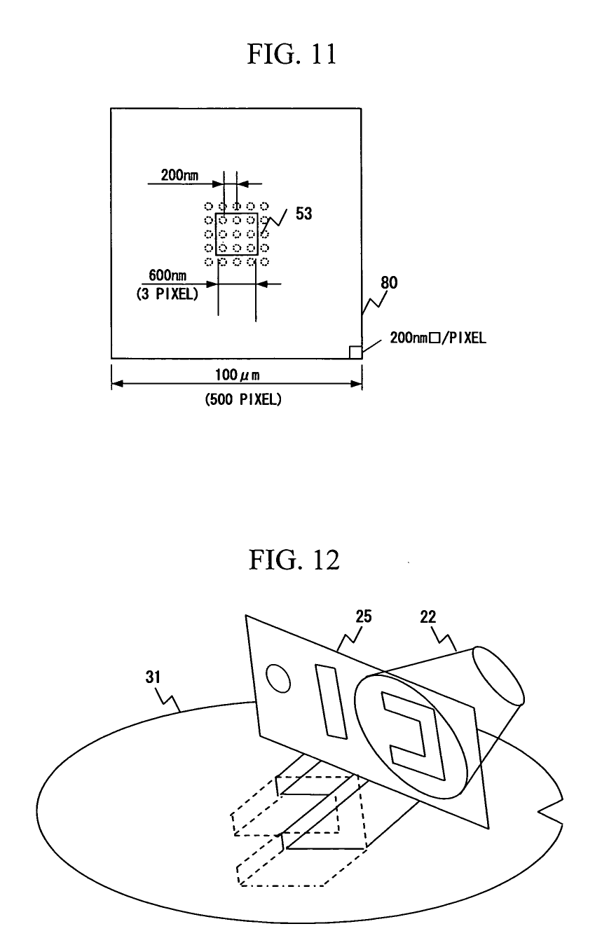

As shown in FIG. 10, the mark formed by the SEM column 10 is searched using the ion beam 22 in which the mask 25 is set to the scanning beam mode. As shown in FIG. 11, even if an image is displayed at a magnification where the 200 nm beam diameter corresponds to one pixel, the mark is recognizable because the mark having a length of 600 nm on one side may be displayed by 3×3 pixels.

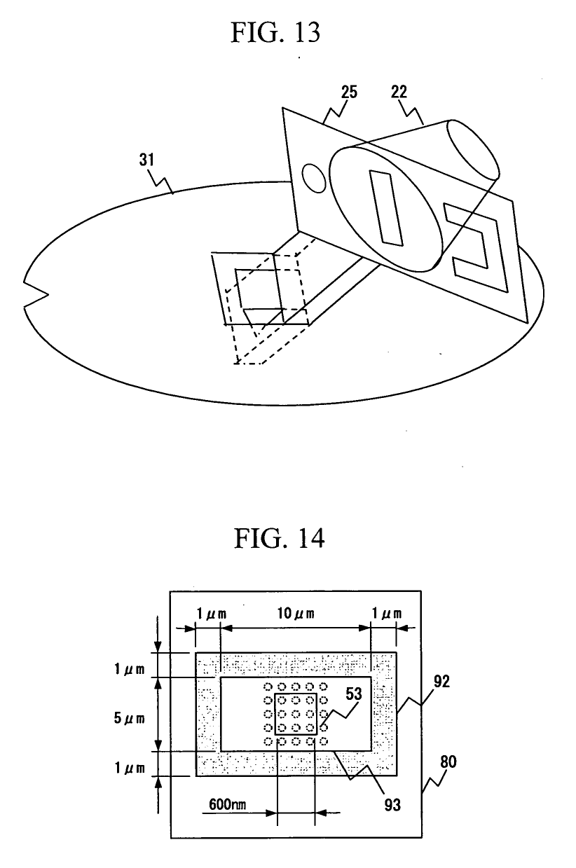

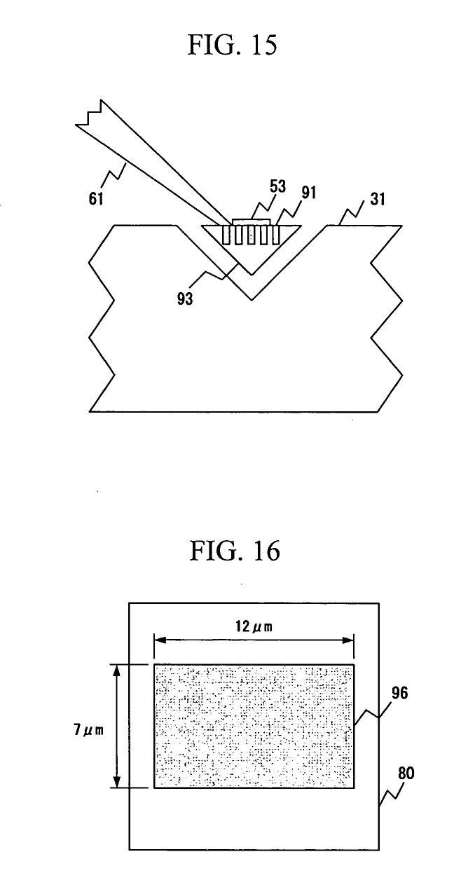

As shown in FIG. 12, a U-shaped groove is machined using the ion beam 22 in which the mask 25 is set to the machining beam mode. Subsequently, as shown in FIG. 13, a rectangular groove is machined after rotating the sample stage 33 by 180°. At this time, since the sample stage 33 may not be accurately rotated about the machining position, the ion beam is switched to the scanning ion beam mode, and thereby the mark is searched for the purpose of setting the machining position. FIG. 14 shows an example in which a machining groove 92 having a width of 1 μm is machined around the sample piece 93, in order to take out the sample piece 93 of 10 μm×5 μm. In this groove machining, a high-speed machining is achieved by machining with a projection beam using a mask having a shape for the machining. As shown in FIG. 15, the sample piece 93 separated by the groove machining is pulled up with a probe 61. The adhesive strength between the sample piece 93 and the probe 61 at this time relies on an electrostatic force. If the attraction of the electrostatic force is weak, these are adhered by a deposition layer 54 which is formed by irradiating the ion beam 22 while supplying the deposition gas 52.

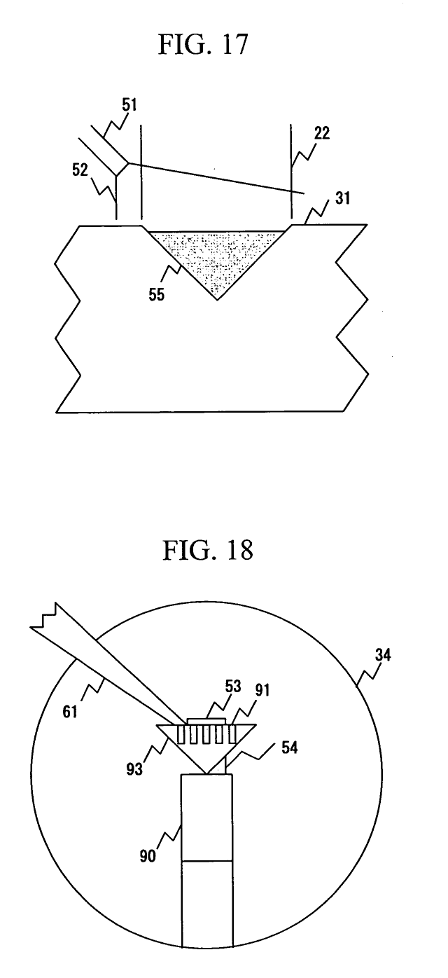

As shown in FIG. 16, in the wafer 31 after the sample piece 93 is taken out, a machining hole 96 remains. Returning the wafer with the hole being left to the manufacturing line may cause a problem in the next process. Accordingly, as shown in FIG. 17, the machined hole is refilled by irradiating the ion beam 22 while supplying the deposition gas 52. At this time, for the mask 25 of the ion beam column 20, the one fitting the machining hole is selected.

As shown in FIG. 18, the sample piece 93, which is taken out, is moved to the upper part of the sample carrier 90 held to the cartridge 34, and is fixed by the deposition layer 54 which is formed by irradiating the ion beam 22 while supplying the deposition gas 52. Since the cartridge 34 is inclinable, inclining the cartridge makes it possible to observe a SEM image at any angle of the sample piece which is fixed to the sample carrier 90.

The cartridge 34 is held together with the wafer 31 in the wafer holder 32, and is unloaded to the sample exchange chamber 35, and is delivered to the cartridge case 39 by the cartridge carry robot 37. The delivered cartridge 34 may be mounted on the tip of the sample holder 95, which can be inserted in a side entry stage of a high resolution analysis system, such as TEM or STEM, as shown in FIG. 19.

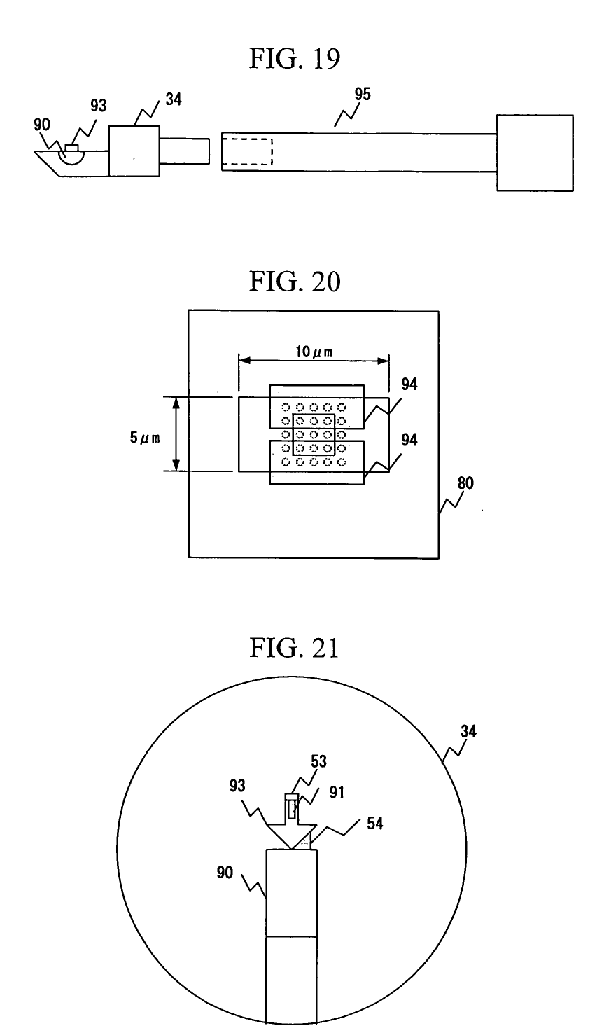

Moreover, the sample holder 95 can be inserted in the side entry stage of the ion beam machining system, and thus machining by use of a narrowed ion beam of a Ga ion source can be further performed. The sample piece 93 taken out from the wafer 31 is contaminated by the irradiation of the Ga ion beam, but is not returned to the line. Accordingly, this will not cause a problem. As shown in FIG. 20, it is known that the center of the mark formed of the deposition layer is the defective contact hole, and a machining region 94 is set so that this portion can be observed by TEM or STEM and then thin machining is carried out. As shown in FIG. 21, the thin-machined sample piece 93 can be analyzed by a high resolution analysis system of an electron beam transmission type such as TEM or STEM. In this way, by marking with the deposition layer 53 using the electron beam 12, the defect position can be accurately analyzed. Moreover, without being contaminated by metal, the wafer can be returned to the line of the manufacturing process. Accordingly, the wafer does not need to be wasted, and consequently an economical effect can be achieved.

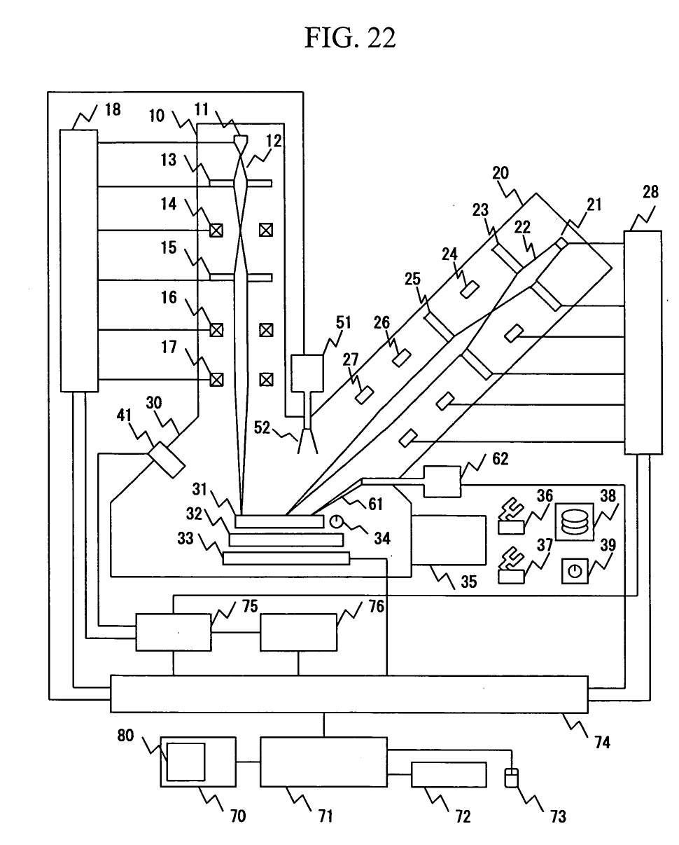

FIG. 22 is a view showing a second embodiment of the semiconductor inspection system of the present invention. The SEM column 10 and the ion beam column 20 are separate from each other in contrast with the first embodiment. Although it is preferable that two columns be close to each other so that the same view area can be observed, this embodiment is an example of a case where the electron beam and the ion beam can not be irradiated at the same position due to mechanical interference. Also in this case, when the marking as illustrated earlier in the SEM column 10 is carried out, the sample piece 93 located at the correct position can be taken out after moving the stage 33 to the side of the ion beam column 20. For this reason, a gas nozzle is made movable so that the gas from the deposition gas source 51 can reach a portion to be irradiated by each beam. This may be also accomplished by installing two nozzles respectively at positions to be irradiated by the corresponding beams.

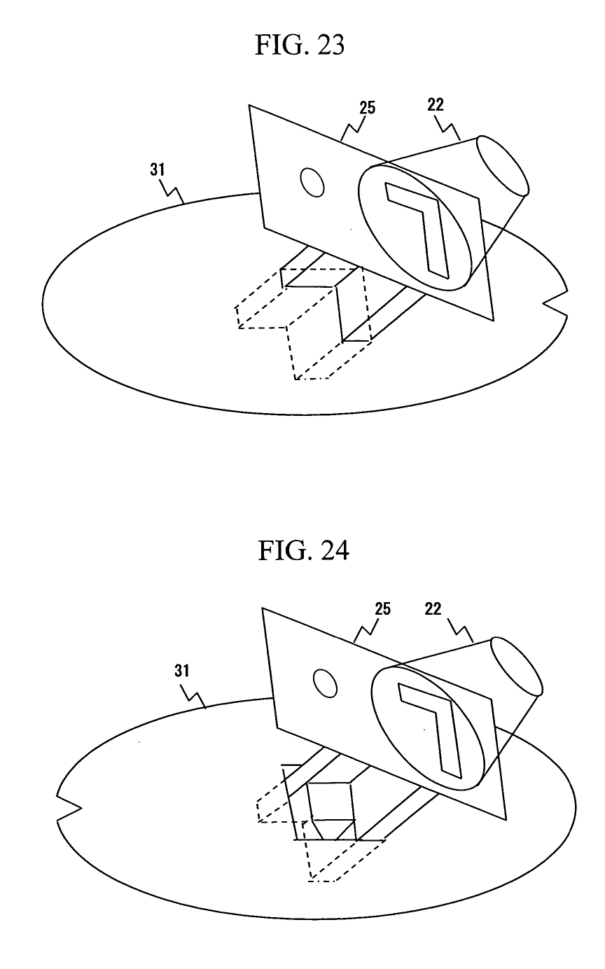

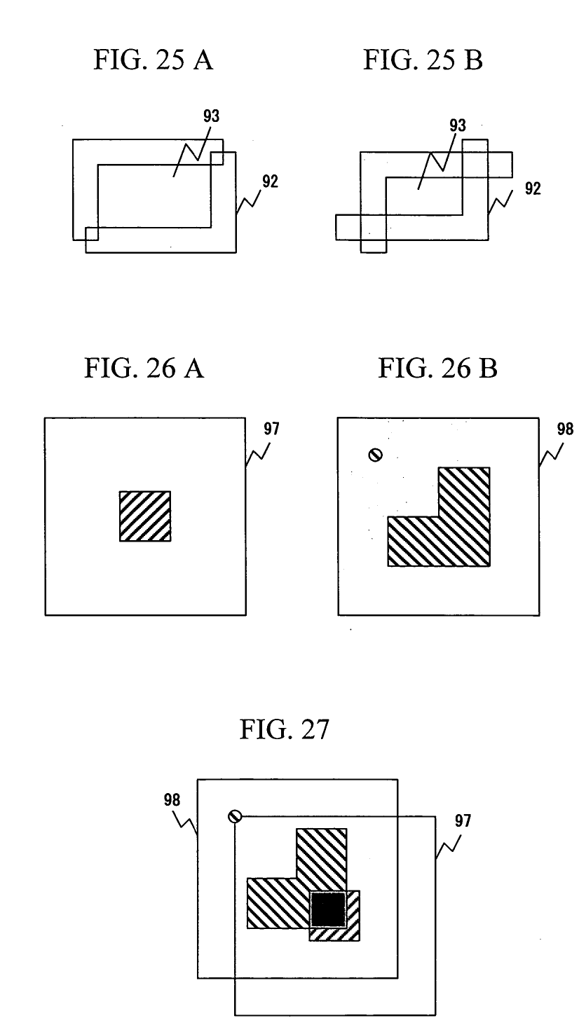

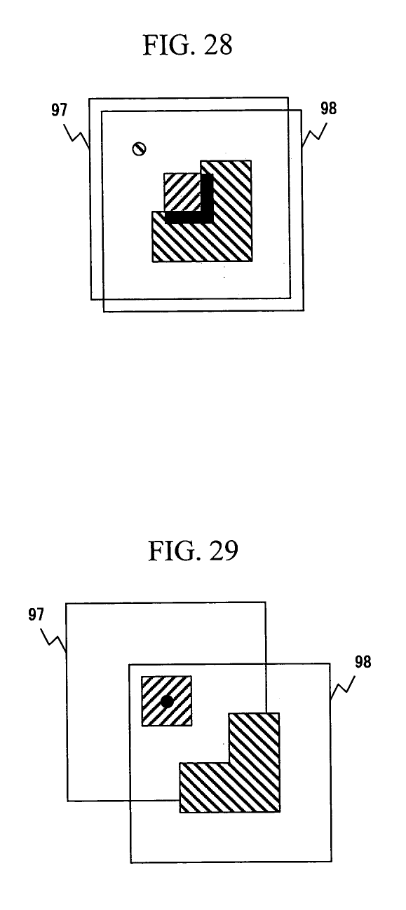

FIG. 23 is a view showing an example in which the mask 25 is formed into an L-shape in contrast with the first embodiment. FIG. 24 is a view showing a state in which the stage 33 is rotated by 180°. There is no flexibility in the size of the sample piece to be taken out when the mask shape is U-shaped. However, it is possible to take out a rectangular having a high flexibility by combining one type of mask shape with a beam shift by means of the deflector 26, when the mask is formed into an L-shape, as shown in FIGS. 25A and 25B. In order to carry out the machining having higher flexibility, two masks shown in FIGS. 26A and 26B are combined. A mask having a rectangular hole opened as shown in FIG. 26A is used as a fixed mask, above which a mask having a circular hole and an L-shaped hole opened as shown in FIG. 26A is moved. In this manner, a rectangular beam shown in FIG. 27, an L-shaped beam shown in FIG. 28, and a circular beam for the scanning beam shown in FIG. 29 may be selected.

Although the embodiments of the present invention is heretofore described, the present invention is not limited to the above described embodiments, and it should be appreciated by the person skilled in the art that various modifications are possible within the scope of the invention claimed.

What is claimed is:

1. A charged particle beam system comprising:
a sample stage capable of being moved while holding a sample;
an electron beam column including an electron source and an electron beam optical system, which focuses an electron beam generated from the electron source, and which scans and irradiates the focused electron beam onto a sample;
an ion beam column including a gas ion source, a mask whose shape is selectable, and an ion beam optical system which irradiates, onto the sample, an ion beam generated from the gas ion source, and then transmitted through the mask;
a detector for detecting a sample signal generated from the sample by the irradiation of any one of the electron beam and the ion beam; and
an arithmetic unit for capturing the signal of the detector, and for generating a sample image, wherein
the ion beam column generates any one of a narrowed ion beam and a wide projection beam, depending on the selection of the shape of the mask, and on the control of the ion beam optical system.

2. The charged particle beam system according to claim 1, wherein
the narrowed ion beam is scanned and irradiated onto the sample, and
the projection beam is irradiated, without being scanned, onto the sample as a beam with a shape depending on that of the mask.

3. The charged particle beam system according to claim 2, further comprising a deposition gas source for forming a deposition layer on a surface of the sample by the irradiation of any one of the electron beam and the ion beam.

4. The charged particle beam system according to claim 3, wherein
the deposition layer, which is formed on the surface of the sample by the electron beam, is detected as a mark by using the image, which is generated in the arithmetic unit by using the narrowed ion beam, and
on the basis of the position of the detected mark, a sample machining is carried out by using the projection beam.

5. A semiconductor inspection system comprising:
a sample stage capable of being moved while holding a semiconductor sample;
an electron beam column including an electron source and an electron beam optical system, which focuses an electron beam generated from the electron source, and which scans and irradiates the focused electron beam onto the sample;
an ion beam column including a gas ion source, a mask whose shape is selectable, and an ion beam optical system which irradiates, onto the sample, an ion beam generated from the gas ion source, and then transmitted through the mask, and the ion beam column generating a narrowed ion beam, which is scanned onto the sample and a wide projection beam with a shape depending on that of the mask, which is irradiated, without being scanned, onto the sample;
a detector for detecting a sample signal generated from the sample by the irradiation of any one of the electron beam and the ion beam; and
an arithmetic unit for capturing the signal of the detector, for generating a sample image, and for processing the sample image, wherein
the defect inspection of a semiconductor sample is carried out by processing a sample image which is obtained by the irradiation of the electron beam from the electron beam column,
a sample image is obtained by using the narrowed ion beam irradiated from the ion beam column, and
a sample machining is then carried out by using the projection beam.

6. The semiconductor inspection system according to claim 5, further comprising a deposition gas source for forming a deposition layer on a surface of the sample by the irradiation of any one of the electron beam and the ion beam.

7. The semiconductor inspection system according to claim 6, wherein
the deposition layer, which is formed on the surface of the sample by using the electron beam, is detected as a mark by using the image, which is generated in the arithmetic unit by using the narrowed ion beam, and
on the basis of the position of the detected mark a sample machining is carried out by using the projection beam.

8. The semiconductor inspection system according to claim 6, wherein the deposition layer is an oxide layer.

9. The semiconductor inspection system according to claim 5, further comprising a probe for taking out a sample piece machined by using the projection beam.

10. The semiconductor inspection system according to claim 9, further comprising a cartridge holding a sample carrier for fixing the taken-out sample piece.

11. The semiconductor inspection system according to claim 10, wherein the cartridge is inclinable.

12. The semiconductor inspection system according to claim 5, wherein the ion beam column is mounted separately from the electron beam column so that a field of view different from that of the electron beam column can be observed.

13. The semiconductor inspection system according to claim 5, wherein
an optical axis of the electron beam column is perpendicular to a moving plane of the sample stage, and
the optical axis of the ion beam column is inclined with respect to the moving plane of the sample stage.

14. The semiconductor inspection system according to claim 5, wherein the mask comprises a first mask to which an L-shaped hole is provided, and a second mask to which a rectangular hole is provided, and which is mounted overlapping the first mask, and
by moving these two masks relatively, a projection beam for a desired one of a rectangular machining and an L-shape machining is irradiated.

15. A method of machining a sample, comprising the steps of:
generating a sample image by scanning an electron beam onto a semiconductor sample, and by detecting a sample signal generated from the sample;
detecting a defect by processing the sample image;
forming a mark made of a deposition layer on a surface of the sample by irradiating an electron beam to a position of the detected defect while supplying a deposition gas thereto;
generating a sample image by narrowing an ion beam generated from a gas ion source, by scanning the narrowed ion beam onto a sample, and by detecting a sample signal generated from the sample;
setting a machining area by detecting the mark in the sample image; and
machining the machining area by using a wide projection beam formed by transmitting an ion beam generated from the gas ion source through a mask having a desired shape.

16. The method according to claim 15, wherein the deposition layer is an oxide layer.

17. The method according to claim 15, wherein the mark made of the deposition layer has a length on one side at least two times larger than the minimum diameter of the narrowed ion beam.

18. The method according to claim 15, wherein the sample piece machined by using the projection beam is taken out by fixing the machined sample piece to a movable probe.

19. The method according to claim 18, wherein
a machining hole made after taking out the sample piece is refilled with the deposition layer formed of the oxide layer by irradiating the projection beam to the machining hole in the semiconductor sample while supplying the deposition gas thereto.
